(19) United States
(12) Patent Application Publication
(10) Pub. No.: US 2013/0151149 A1
(43) Pub. Date: Jun. 13, 2013

(54) VEHICLE NAVIGATION SYSTEM SYNCHRONIZATION WITH USER CALENDAR

(71) Applicants: Johannes Geir Kristinsson, Ann Arbor, MI (US); Ryan Abraham McGee, Ann Arbor, MI (US)

(72) Inventors: Johannes Geir Kristinsson, Ann Arbor, MI (US); Ryan Abraham McGee, Ann Arbor, MI (US)

(73) Assignee: FORD GLOBAL TECHNOLOGIES, LLC, DEARBORN, MI (US)

(21) Appl. No.: 13/313,015

(22) Filed: Dec. 7, 2011

(51) Int. Cl. G01C 21/00; G06F 15/16

(52) U.S. Cl. 701/533; 709/204

(57) ABSTRACT

A Vehicle navigation system connects to a user's smart-phone or an online internet-based calendar service to download a user event schedule/calendar containing a list of upcoming user appointments. The next event within the list is identified, and is searched for the presence of a location identifier, i.e., an appointment venue or the name of the person with whom the appointment is fixed. Upon finding a location identifier, the user is prompted to confirm whether the identified location corresponds to the user's next intended destination, when the time of arriving at the identified location is close to the time when the next appointment occurs. Once the user confirms, the identified location is construed as the next intended destination and a destination input to the navigation system is automatically provided to plan the next trip accordingly.

### BACKGROUND

Navigation systems are predominantly used in automotive vehicles for their continuous and accurate positioning and providing of navigation aids to the drivers. Initially developed navigation systems used to work independently, with no connection to the internet or to any other resources/systems. Recent developments have incorporated limited connectivity of these systems to online sources to receive crucial information regarding the weather, road conditions, and level of traffic congestion. This provides an advantage to the driver, as the driver can plan the most convenient route by utilizing such information. However, the current navigation systems still require manually providing a destination input and a manual interaction of the user/driver with the system is essential for the system to operate and effectively route the driver.

Since the time electronic and internet-based calenders have been in use, many users use these calendars to store essential information regarding their appointment locations and the places where they are scheduled to go. Such calendars are also often stored by the users in their smart-phone devices. However, current vehicle navigation systems have either no or limited integration with these user calendars, and cannot identify or retrieve the next locations where the user is intending to move. The user/driver is still required to manually enter the next desired destination in the system.

Therefore, there exists a need to automate the destination entry in navigation systems for vehicles.

### SUMMARY OF THE INVENTION

The present disclosure describes a vehicle navigation system that synchronizes with the user's event schedule (user calendar) containing the upcoming user appointments, where a destination input to the navigation system is automatically provided by retrieving a relevant entry from the user calendar, without the need for the user/driver to provide the same manually.

In one aspect, this disclosure provides a method for automatically providing a destination input to a vehicle navigation system by synchronizing the navigation system with a user event schedule. The method includes downloading the user event schedule from a source that may be either an online internet based calendar service or the user's mobile device. The user event schedule is a user calendar specifying a list of upcoming user appointments. The next upcoming user appointment is identified from the user event schedule, and is examined for the presence of a location identifier. The location identifier would be the complete address or a specific place corresponding to the next appointment. The user is then prompted to confirm whether the location identifier corresponds to his next intended destination. On receipt of a confirmation by the user, the identified location is construed as the next destination input for the navigation system, and the system plans the trip for the next appointment accordingly.

In another aspect, this disclosure provides a vehicle navigation system synchronized with a user event schedule for automatically providing a destination input to the navigation system. The system includes an automatic sync application connected to a source, and the automatic sync application is configured to download the user event schedule from the source. The source may be either an online internet based calendar service, or a user's mobile device, like a smart-phone. The automatic sync application includes an identification module, a search crawler, a confirmation module, and a route planning processor. The identification module identifies a next upcoming event within the user event schedule. The search crawler crawls through the text/content of the identified next upcoming event, to search for the presence of a location identifier. If such a location identifier is present, the confirmation module generates a confirmation message for the user to approve that the identified location is his next intended destination. On receipt of the confirmation, the route planning processor plans the next user trip. A user interface containing user selectable options for receiving user inputs is also provided in the navigation system. The planned route is rendered on the user interface by depicting a route-map thereof, after the route planning processors plans and generates the map.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 is an exemplary flowchart depicting the steps involved in synchronizing a navigation system with a user event schedule.

FIG. 2 illustrates an exemplary system showing different components/modules of a vehicle navigation system synchronized with a user event schedule in accordance with the current disclosure.

### DETAILED DESCRIPTION OF ILLUSTRATIVE EMBODIMENTS

The following detailed description elucidates aspects of the disclosure and the ways it can be implemented. However, the description does not define or limit the invention, such definition or limitation being solely contained in the claims appended thereto. Although the best mode of carrying out the invention has been disclosed comprehensively, those in the art would recognize that other embodiments for carrying out or practicing the invention are also possible.

The present disclosure pertains to a vehicle navigation system synchronized with a user event schedule, for automatically providing a destination input to the navigation system and planning the trip accordingly.

Global positioning systems/navigation systems are now widely used in vehicles for determining their exact locations, in terms of parameters including their latitude, longitude and altitude on the earth. For locations where there is an unobstructed line of sight to a plurality of GPS satellites revolving around the earth, the GPS systems are capable of determing relatively exact locations in most weather conditions. GPS receivers used in these systems receive GPS signals from various GPS satellites, and process these signals to perform GPS positioning. The exact time taken to receive the GPS signals sent from GPS satellites is calculated and this information is further used to figure out the accurate location of vehicles.

Further, many vehicles now are equipped with SYNC systems, which are factory assembled in-vehicle communication systems, that allow drivers to control a music system through voice commands, and to easily make hands-free telephonic calls. An example of the same is the Ford SYNC system that is currently available in about fourteen different models of Ford vehicles. The SYNC systems now are also integrated with the vehicle navigation/GPS systems, so the driver can provide destination inputs for planning their upcoming trips.

With the gradual advancement in technology, the usage of smart-phones by the drivers has been predominant, and most of the information pertaining to their upcoming appointments is now stored in their calendars, which can be easily retrieved from their smart-phones, or current online internet-based calendar services containing user calendars. However, these user calendars stored in their mobile devices, have limited integration with the GPS/navigation system applications in their vehicles, and a manual interaction of the user with the navigation system is still required to provide destination inputs.

The present disclosure synchronizes the vehicle navigation system with user calendars stored in their smart phones or available online through internet based calendar services, retrieves relevant information regarding the next user appointment, and suggests a next probable destination input for the navigation system, based on the information.

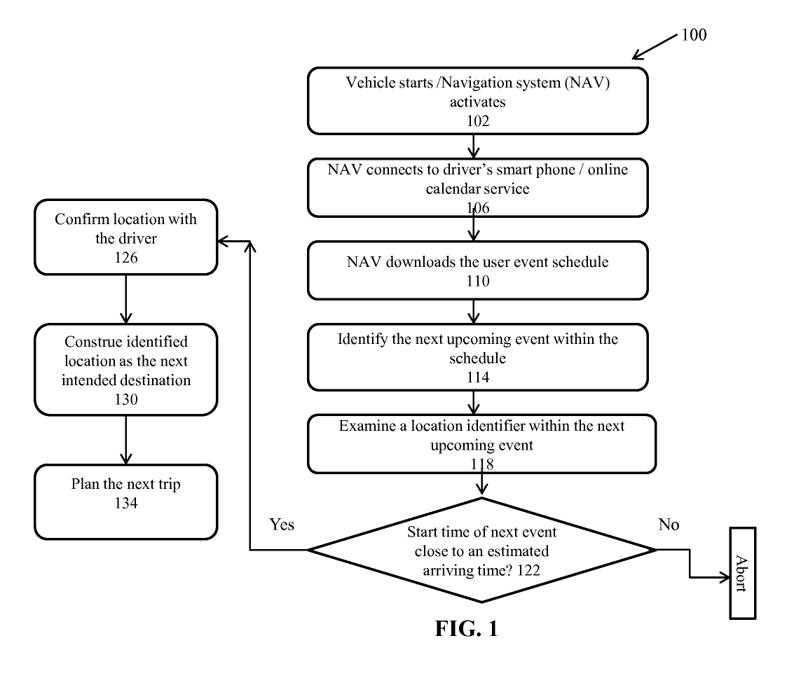

The FIG. 1 flow-chart discloses the sequential steps involved in synchronizing a vehicle navigation system with a user event schedule/calendar, for automatically providing a destination input to the navigation system. As illustrated, at step 102, the driver starts the vehicle, and the navigation system (hereinafter referred to as ‘NAV’) gets activated. At step 106, the navigation system connects to the driver's smartphone, which contains a user event schedule, or a user calendar including a list of upcoming user appointments. The NAV contains an automatic sync application (disclosed in details hereinafter) that has the ability to automatically connect to the user/driver's smart-phone, or has access to the internet through which it connects to an online internet-based calendar service. In general, the user calendar contains an ordered list of all the upcoming user appointments, arranged sequentially in the order of their times of occurrence. If the user event schedule is available through the online internet-based service, like Google Calendar, Apple's MobileMe or iCloud Calendar or an exchange server, for example, the NAV connects with the internet to access the event schedule/calendar. At step 110, the NAV downloads the user event schedule from the smart-phone device or the online service. At step 114, the NAV identifies a next upcoming event within the user event schedule or the user calendar. This next event would correspond to the next user appointment. At step 118, the identified next event is examined for the presence of a location identifier. The location identifier corresponds to the complete address/place where the next user appointment is located, or to other identifiable information regarding the location of the next appointment, including a street number, a person's name, whose address is already stored in the user's smart-phone, etc. At step 122, it is identified whether the start time of the next appointment is close to an estimated time of arrival of a possible trip planned to the identified location. When these two times are in proximity, then at step 126, the NAV generates a confirmation message, prompting the user to confirm whether the identified location corresponds to his next intended destination. This confirmation lets the user catch situations where the NAV may identify an incorrect next location. Altogether, the user/driver notices only a confirmation window for the identified target location, over the display screen of the navigation system. At steps 130 & 134, on receipt of the confirmation from the user, the system determines the identified location as the next intended destination, and automatically provides the corresponding destination input to plan the next trip. This avoids the need for the driver to provide any manual input corresponding to his intended destination.

The system is also capable of searching the identified next upcoming event/user appointment for a set of pre-defined tags, to simplify the search for a location identifier at step 118. Drivers usually pre-define and store certain addresses corresponding to more frequently visited places in their smart-phones. If these addresses are stored with specific tag names, then the system is capable of identifying those tags in the next user appointment, and can retrieve the corresponding complete address from the phone's database. As an example, the user can define the term/tag ‘Office’ corresponding to his office address, and store the corresponding address in his smart-phone. For logging a next appointment at his office in his calendar, as an example, the user would just need to enter the word ‘Office’ or a short phrase like ‘meeting at office’ in the calendar. When the system identifies the tag ‘Office’ in the next appointment of the user's calendar while searching therein, it would automatically retrieve the complete office address from the phone's database, and ask the user for a confirmation.

In one embodiment, the system keeps track of the previous user destinations and stores the corresponding complete addresses. While searching the upcoming user appointment for a location, the system examines it for the presence of a set of keywords matching those in the list of previous user destinations. For instance, the first time a user plan's a trip to a friend's house, he may have to specify the complete address in his calendar of appointments, for example: John's house, 727, Baker's street, London. The next time the user visits the same destination, he just needs to log the appointment by specifying ‘John's House’ in his event schedule/calendar. The system would automatically identify this location by linking it to its complete address stored previously, and retrieve it from the database.

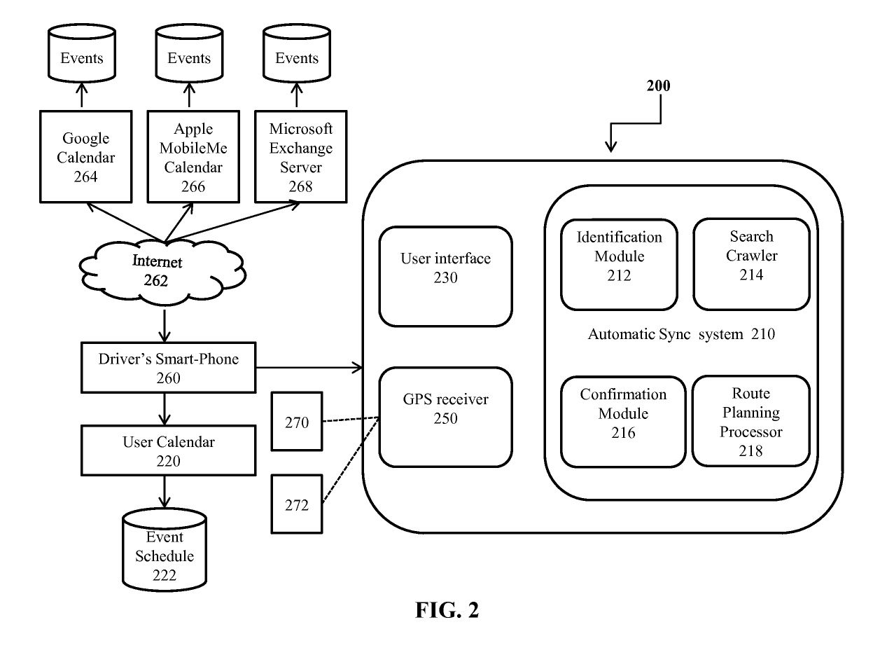

FIG. 2 illustrates the different components of the automatic vehicles navigation system 200 (hereinafter NAV 200) synchronized with a user calendar, in accordance with the present disclosure. Navigation system 200 includes an automatic sync application 210, a user interface 230 and a GPS receiver 250. Automatic sync application 210 is configured to connect to the driver's smart phone 260 either wired or wirelessly through the internet, or via Wi-Fi or a Bluetooth connection, like the way it happens in the current SYNC systems in vehicles. In one embodiment, the automatic sync application 210 is further linked to the internet source 262, either through a connectivity terminal provided in the vehicle or indirectly through the driver's smart-phone 260. In other embodiments, only a connection to the driver's smart phone is required. Various on-line calendar services are available where the user can upload his event schedule/calendar corresponding to all of his upcoming appointments. These services may include any such service available and provided by Google or Apple, for instance, the Google Calendar service 264 or the Apple MobileMe or ICloud calendar service 266 or the Microsoft exchange server 268 etc. As shown, these services have their own databases of events from which the user calendar is downloadable. The automatic sync application 210 may be directly connected to one of these online internet-based calendar services to download the user calendar 220. In such cases, the NAV 200 would store an encrypted user name and password corresponding to the user's calendar, to maintain security.

Automatic Sync application 210 includes an identification module 212, a search crawler 214, a confirmation module 216 and a route planning pre-processor 218. Identification Module 212 functions to identify the next upcoming event/user appointment within the user calendar 220. Usually, the user calendar 220 will include a user event schedule 222 which is a comprehensive list of upcoming user appointments for a certain period. The user may either store the appointments sequentially in the order of their occurrence, or randomly by specifying dates and times corresponding to those appointments. The period may be the current day, or the current week or may even be the current running month, etc., based on the user priorities. Identification module 212 is capable of identifying the next upcoming appointment, and may also sort all those appointments in a sequential order based on their times of occurrence. Once the next upcoming user appointment is identified, the search crawler 214 performs a search to examine the presence of a location identifier within the appointment. The location identifier could be the exact and complete address corresponding to the venue of the next appointment, a name for the person/organization with whom the next appointment is fixed, or may also be a tag or a keyword pre-defined by the user/driver corresponding to the venue for the next appointment. For instance, if the user has a next appointment with one of his frequently visited friends named Joseph E. Root, with his complete address being 3156, Eagle Way, Montana, Calif., United States, then he just needs to store this complete address in his smart phone by his name, and specify the appointment shortly as: ‘Meeting with Joseph at 1:00 p.m’. The search crawler 214 would crawl through the text and retrieve the pre-defined tag ‘Joseph’ within the appointment, and retrieve the corresponding complete address from the user's smart-phone. In an advanced implementation, the Automatic sync application 210 tracks and stores the previous destinations where the user visited. The next time the user has an appointment scheduled at any one of those previously stored destinations, the search crawler can link the short tag for the destination with its corresponding complete address stored earlier.

Once a location identifier is found present in the next appointment, confirmation module 216 generates a confirmation message on the user interface 230. The message prompts the user to confirm whether the identified location is the user's next intended destination. This confirmation message is generated when the time of arrival to the next destination is close to the identified next scheduled appointment. This enables the user/driver to catch the instances when the system has identified a fault address. When the user confirms positively on the message, the identified location is construed as the next intended destination by the navigation system 200 and the route planning processor 218 accordingly plans the next intended trip.

Several attributes of the planned route may be displayed on the user interface in the form of a map showing the current location, the final destination and the approximate arrival time. Optionally, the system would also display the weather conditions, the traffic congestion and suggest other possible, feasible and more appropriate routes to reach the intended destination based on these conditions. The route planning processor 218, while planning the intended route, continuously considers all these traits.

The GPS receiver 250 for the vehicle navigation system 200 is continuously coupled to and receives signals from the GPS satellites 270, 272 etc. to locate the position of the vehicle at all times and provide navigation aids to the driver.

The disclosed automatic vehicle navigation system synchronized with the user calendar can be used in any vehicle with a system connectable to the driver's smart-phone either wirelessly, or through a wired network. Further, it can also be used in vehicles with a navigation/GPS system that may have suitable means to access the internet, may it be through the driver's data-service enabled phone or through a connectivity terminal built in the vehicle.

Although the current invention has been described comprehensively, in considerable details to cover the possible aspects and embodiments, those skilled in the art would recognize that other versions of the invention may also be possible.

What is claimed is:

1. A method for automatically providing a destination input to a vehicle navigation system, the method comprising:
downloading a user event schedule from a source;
identifying an upcoming event within the user event schedule;
examining the upcoming event for the presence of a location identifier;
prompting a user to confirm whether the location identifier corresponds to the user's next intended destination; and
providing the destination input to the vehicle navigation system based on the confirmation.

2. A method of claim 1, wherein the user is prompted when a specific time remains before the occurrence of the upcoming event.

3. A method of claim 1, wherein the user event schedule is a calendar including an ordered list of user appointments.

4. A method of claim 1, wherein the source is an online internet-based calendar service.

5. A method of claim 1, wherein the source is a user mobile device containing a user calendar representing the user event schedule.

6. A method of claim 1, wherein the examining comprises searching the upcoming event for a set of user pre-defined tags that correspond to a set of pre-determined addresses.

7. A method for synchronizing a user event schedule with a vehicle navigation system, the method comprising:
connecting the navigation system to a source including a user event schedule;
downloading the user event schedule from the source and identifying a next upcoming event therein;
examining the next upcoming event for the presence of a location identifier; and
prompting the user to confirm whether the location identifier corresponds to his next intended destination; and
planning with the vehicle navigation system a next trip based on the confirmation.

8. A method of claim 7, wherein the user is prompted when a specific time remains before the occurrence of the upcoming event.

9. A method of claim 7, wherein the user event schedule is a user calendar containing an ordered list of upcoming user appointments.

10. A method of claim 7, wherein the source is a user mobile device containing a user calendar representing the user event schedule.

11. A method of claim 7, wherein the source is an online internet-based calendar service containing a user calendar.

12. A method of claim 7, wherein the examining comprises searching the upcoming event for a set of user pre-defined tags that correspond to a set of pre-determined addresses.

13. A vehicle navigation system synchronized with a user event schedule for automatically providing a destination input to the navigation system, the system comprising:
an automatic sync application connected to a source and configured to download a user event schedule from the source, the automatic sync application further comprising:
an identification module configured to identify a next upcoming event within the user event schedule;
a search crawler configured to examine the next upcoming event for the presence of a location identifier;
a confirmation module configured to generate a confirmation message and prompt the user to confirm whether the location identifier corresponds to the user's next intended destination; and
a route planning processor configured to plan a route of travel based on the confirmation;
a user interface configured to render a set of user selectable options for providing user inputs and for displaying a map depicting the planned route.

14. A vehicle navigation system of claim 13, wherein the confirmation module generates the confirmation message at a specific time before the upcoming event starts.

15. A vehicle navigation system of claim 13, wherein the user event schedule is a user calendar including an ordered list of user appointments.

16. A vehicle navigation system of claim 13, wherein the source is an online internet-based calendar service.

17. A vehicle navigation system of claim 13, wherein the source is a user mobile device.

18. A vehicle navigation system of claim 13, wherein the search crawler is configured to search the user event schedule for a set of pre-defined tags corresponding to a set of pre-determined addresses.
